(19) United States
(12) Patent Application Publication
(10) Pub. No.: US 2004/0182692 A1
(43) Pub. Date: Sep. 23, 2004

(54) Method for treating a product stream containing vitamin e acetate

(76) Inventors: Harald Laas, Maxdorf (DE); Jens von Erden, Altrip (DE); Frank Kinner, Mauer (DE); Bernd Rumpf, Hockenheim (DE)

Correspondence Address: KEIL & WEINKAUF, 1350 CONNECTICUT AVENUE, N.W., WASHINGTON, DC, 20036, US

(21) Appl. No.: 10/484,249

(22) PCT Filed: Jul. 9, 2002
(86) PCT No.: PCT/EP02/07610

(30) Foreign Application Priority Data
Jul. 21, 2001 (DE) 101 35 714.1

(51) Int. Cl. B01D 1/22; B01D 3/14; B01D 3/06

(52) U.S. Cl. 203/87; 203/88; 203/89; 159/49

(57) ABSTRACT

A method for processing a vitamin E acetate-containing product stream, which comprises

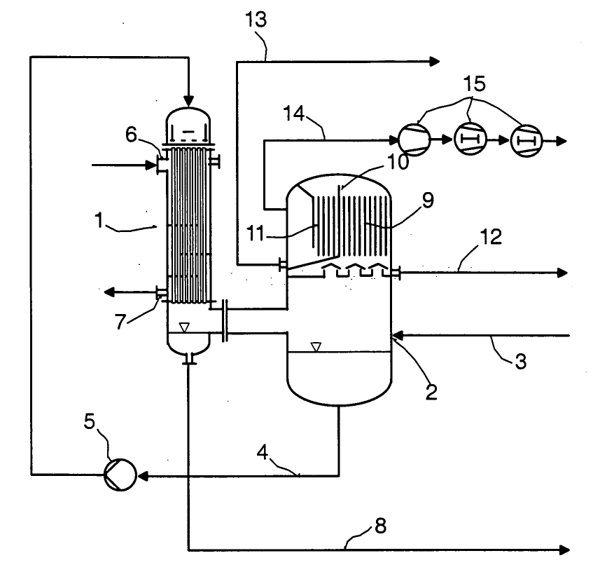

a) feeding the product stream to a thin film evaporator, falling film evaporator or flash evaporator and there removing as bottom stream a predominantly vitamin E acetate-containing stream and

b) feeding the vapor stream from stage a) to an at least two-stage partial condensation.

Falling film evaporator for fractionating mixtures of substances, where one or more heat exchangers are directly integrated into the vapor space of the falling film evaporator.

The present invention relates to an improved method for processing a vitamin E acetate-containing product stream.

The preparation of α-tocopherol (vitamin E) takes place on the industrial scale for example by condensing 2,3,5-trimethylhydroquinone with isophytol in the presence of zinc chloride and hydrochloric acid. Methods for synthesizing 2,3,5-trimethylhydroquinone are described, for example, in the patents U.S. Pat. No. 2,411,969, U.S. Pat. No. 4,239,691, U.S. Pat. No. 3,708,505 and DE 3203487 and DE 4243461.

The α-tocopherol which is obtained is usually esterified by reaction with acetic anhydride to tocopherol acetate—also called vitamin E acetate. Methods for converting α-tocopherol into tocopherol acetate are described, for example, in patents EP 0850937, DE 19603142 and DE 4208477. Vitamin E acetate—also abbreviated to VEA hereinafter—is employed inter alia as antioxidant and in the area of human and livestock nutrition.

The substantial residues of acetic acid and acetic anhydride in the reaction mixture obtained on esterification can be removed, for example, by single-stage or multistage distillation steps in falling film evaporators, thin film evaporators or the like. After this, such a reaction mixture normally contains about 94% by weight VEA, 1-2% by weight low boilers (mainly phytodienes), about 2-3% by weight unspecified isomers of the required product (VEA) and 1-2% by weight high boiling subsidiary components.

The isolation of VEA from this reaction mixture must, because of the thermal sensitivity of the required product and the position of the thermodynamic equilibria, take place by multistage distillation under medium vacuum. On the large scale, cascades of short-path evaporators operated at pressures of about 10⁻³ mbar are employed, for example. Apparatuses of this type are described, for example, in Billet, R., Verdampfertechnik, Bibliographisches Institut, Mannheim, 1965. The dimensions and the operation of the short-path evaporators and of the vacuum system for the very low pressures required are determined by the need for the removal of the low boilers from the product stream flowing into the cascade of short-path evaporators to be as complete as possible. For this reason, a thin film evaporator operated at about 1 mbar to remove the low boilers is normally upstream of the cascade of short-path evaporators. The vapor stream generated in the thin film evaporator essentially contains phytadienes, vitamin E acetate and residues of acetic acid and acetic anhydride and is almost completely condensed in a downstream condenser system. The resulting condensate cannot be used further, because of the high content of low boilers, and is therefore discarded. Because of the position of the phase equilibria, this vapor stream contains about 13% by weight VEA, and the VEA loss is about 2.7% based on the amount of VEA flowing in. The low boiler content remaining in the required product (bottom product from the thin film evaporator) is normally about 2% by weight.

The bottom product from the thin film evaporator is fed to the cascade of short-path evaporators where the vitamin E acetate is further concentrated by repeated evaporation and condensation.

The described method has several disadvantages, however. As already described, part of the required product (VEA) passes via the gas phase out of the thin film evaporator into the downstream condenser system and is eventually lost. It has additionally been found that only some of the low boilers are removed in the thin film evaporator, while the rest remains in the required product and must later be removed in a complicated manner. In addition, a thin film evaporator is a relatively elaborate and costly apparatus because of the internal-rotating wiper systems.

It is an object of the present invention to find a method for processing a VEA-containing product stream which remedies said disadvantages and which provides an economic and technically simple way of removing VEA of high purity. The method should additionally allow the use of technically simple separation apparatuses.

We have found that this object is achieved by a method for processing a vitamin E acetate-containing product stream, which comprises

a) feeding the product stream to a thin film evaporator, falling film evaporator or flash evaporator and there removing as bottom stream a predominantly vitamin E acetate-containing stream and

b) feeding the vapor stream from stage a) to an at least two-stage partial condensation.

In the method of the invention, a thin film evaporator, flash evaporator or, preferably, falling film evaporator is employed to remove the low boilers. In general, this stage of the method serves essentially to remove the low boilers.

The thin film evaporator is an evaporator with internal rotating wiper system. It is described, for example, in Billet, R., Verdampfertechnik, Bibliographisches Institut, Mannheim, 1965.

The flash evaporator is a heat transfer device in which the product stream flowing in is superheated and then decompressed in a vapor vessel in which separation of vapor and liquid takes place. Flash evaporators of this type are described, for example, in Billet, R., Verdampfung und ihre technischen Anwendungen, Verlag Chemie Weinheim, 1981.

In the falling film evaporator, normally the mixture of liquids to be separated flows, after pathing through an appropriate delivery device, downward in the form of a film along the interior walls of a heated tube bundle heat exchanger standing vertically. The vapor stream produced through the heat input flows co-currently with the liquid. A separator is usually disposed directly underneath the tubes of the tube bundle heat transfer device, and separation of vapor and liquid takes place there. Falling film evaporators are described, for example, in Billet, R., Verdampfung und ihre technischen Anwendungen, Verlag Chemie Weinheim, 1981.

The vapor stream taken off from the first stage is fed into an at least two-stage condensation stage. The heat transfer devices which can be employed here are, for example, horizontal or vertical tube bundle apparatuses, and plate apparatuses are particularly suitable. These heat exchangers are operated so that the vapor stream is partially condensed. It is thus possible in particular for a considerable amount of required product (VEA) to be recovered by means of the first heat exchanger downstream of the first stage of the method. The amounts are about 2.7% by weight based on the amount of the stream of vitamin E acetate flowing in.

There is in principle no limitation on the number of heat exchangers, and normally two or three thereof will be used.

In a preferred embodiment of the method, a falling film evaporator with which the heat exchangers for the downstream partial condensation are directly integrated into the vapor space is employed. This compact and simple construction makes it possible to minimize pressure loss, and it is economically and technically worthwhile to use a falling film evaporator for this method even at relatively low pressures. It is thus possible to operate at pressures down to about 1 mbar, preferably down to 5 mbar, in this method without excessive strain on the downstream vacuum system. By contrast, commercially available falling film evaporators can be employed in an economically and technically worthwhile manner only in the low pressure range at pressures down to about 50 mbar.

The method of the invention is described in detail the example shown in the figure. A falling film evaporator (1) with internal, preferably vertical, tube bundle heat exchanger and vapor space (2) connected thereto is fed with the mixture of substances to be separated through line (3). This mixture contains about 94% by weight VEA, 1-2% by weight low boilers (mainly phytadienes), about 2-3% by weight unspecified isomers of the required product (VEA) and 1-2% by weight high boiling subsidiary components. At the base of the vapor space, liquid product is pathed through line (4) and pump (5) via an appropriate distributor device into the tube bundle heat exchanger. The product stream in the pipes is heated via the connectors (6) and (7) with superheated steam or a suitable heat transfer oil to an exit temperature of about 243° C. The liquid phase which forms collects at the lower end of the tube bundle heat exchanger and is taken off through line (8). This substance stream essentially contains about 96% VEA, 0.3% low boilers, about 1.3% high boilers and about 2.4% isomers of the required product VEA and is fed to the cascade of short-path evaporators which is not depicted. The VEA is concentrated further here by repeated evaporation and condensation. It is possible in this case to achieve VEA purities of up to about 99% by weight.

The heat exchanger system is disposed directly in the upper part of the vapor space. It consists of two plate exchangers (9, 11) which are separated from one another by the partition (10). The two-stage arrangement of the heat exchanger system advantageously makes it possible for mixtures of substances of varying compositions to be partially condensed through lines (12), (13). The substance stream taken off through line (12) contains, depending on the chosen condensation conditions, about 84% VEA, 12% low boilers together with isomers of VEA, and in the process is admixed with the distillate stream from the first short-path evaporator. The resulting mixture can, because of its content of VEA, be employed for example for animal nutrition. The substance stream taken off through line (13) contains about 98% low boilers and about 2% VEA and is discarded. The vapors arriving at the top of the vapor space are drawn off through line (14) and vacuum system (15). The falling film evaporator is operated under a pressure of about 1 to 10 mbar, preferably 2 to 5 mbar.

In the depicted example, the bottom offtake through line (8) is disposed separate from the vapor space. This variant may prove to be particularly advantageous because it is possible in this way to utilize the concentration differences between the liquid in the vapor space and the product stream running out of the tube bundle. It may moreover be possible, depending on the chosen operating conditions, for the low boilers present in the feed to be almost completely removed. It is thus possible to diminish the low boilers at the outlet from the falling film evaporator to about 0.3% by weight.

Examples of suitable heat exchangers for the partial condensation are tube coils or tube bundles, but plate heat exchangers are preferably employed. Because of their relatively high heat transfer coefficients, they provide high efficiency and, moreover, open up the possibility of specifically adjusting the operating conditions of the individual partial condensers. The specific operating conditions depend on the overall conditions and specifications in each case. They can be established by the skilled worker by routine tests in each case.

As previously described, it may be advisable to site the bottom offtake separate from the vapor space. In this way, advantageous use is made of the concentration differences between the vapor space and the product stream flowing out of the tube bundle, whereby it is possible to make the separation even more efficient.

The bottom offtake can, however, also take place in the vapor space or in the circulating stream. Alternatively, an overflow weir can be put in the vapor space, in which case it is possible by defined measures to prevent almost complete back-mixing of the liquid substance stream flowing out of the tube bundle and the liquid stream (3) flowing into the vapor space.

### EXAMPLE

The separation results in the method of the invention and a separation by a previously customary procedure are compared below by means of an example and of a comparative example.

### Example 1 (Not According to the Invention)

Partial evaporation of a product stream flowing at 1000 g/h into a laboratory thin-film evaporator with a composition of 2.6% low boilers, 94.1% VEA, 1.2% high boilers and 2.1% isomers of VEA under a pressure of aboout 3 mbar. Complete condensation and removal of the vapor stream with 44.9% low boilers, 52.6% VEA and 2.5% isomers of VEA. Analysis of the bottom product flowing out at 243° C. revealed a composition of 0.6% low boilers, 96% VEA, 1.3% high boilers and 2.1% isomers of VEA. VEA loss: 2.5% based on the amount of VEA flowing in.

### Example 2 (According to the Invention)

Partial evaporation of a product stream flowing at 1000 g/h into a laboratory falling film evaporator equipped with a separate bottom and a condenser system consisting of two condensers. The composition of the product stream flowing in was 2.6% low boilers, 94.1% VEA, 1.2% high boilers and 2.1% isomers of VEA. The temperature of the product stream flowing out of the tube bundle was set at 2430C under a pressure of 3 mbar. The temperature of the outflow from the first condenser was set at 180° C., and the temperature for almost complete condensation of the remaining vapors was 150° C. Analysis of the substance stream flowing out of the first condenser revealed the following composition: 13.5% low boilers, 83.9% VEA, 2.6% isomers of VEA. Analysis of the stream flowing out of the downstream complete condenser revealed a composition of 97.9% low boilers, 2% VEA and residues of isomers of VEA. Analysis of the bottom product revealed virtually the same values as in the previous example. VEA loss: 0.03% based on the amount of VEA flowing in.

We claim:

1. A method for processing a vitamin E acetate-containing product stream, which comprises
a) feeding the product stream to a thin film evaporator, falling film evaporator or flash evaporator and there removing as bottom stream a predominantly vitamin E acetate-containing stream, and
b) feeding the vapor stream from stage a) to an at least two-stage partial condensation.

2. A method as claimed in claim 1, wherein tube coils, tube bundles and/or plate heat exchangers are employed as heat exchangers for the partial condensation.

3. A method as claimed in claim 1 or 2, wherein the heat exchangers for the condensation are disposed directly in the vapor space of the falling film evaporator.

4. A method as claimed in claims 1 to 3, wherein the bottom offtake from the falling film evaporator is disposed separate from the vapor space.

5. A process as claimed in claims 1 to 4, wherein an overflow weir is disposed in the vapor space of the falling film evaporator and thus back-mixing of the bottom stream with the product stream flowing into the vapor space is completely or partially prevented.

6. A method as claimed in claims 1 to 5, wherein a two- or three-stage partial condensation is carried out.
